(19) United States
(12) Patent Application Publication
(10) Pub. No.: US 2008/0265705 A1
(43) Pub. Date: Oct. 30, 2008

(54) Rotary Machine and Electromagnetic Machine

(76) Inventor: Yukio Kinoshita, Ibaraki (JP)

Correspondence Address: DAY PITNEY LLP, 7 TIMES SQUARE, NEW YORK, NY, 10036-7311, US

(21) Appl. No.: 10/566,891

(22) PCT Filed: Aug. 2, 2004
(86) PCT No.: PCT/US04/25134

§ 371 Date: Jun. 9, 2008

(30) Foreign Application Priority Data
Aug. 2, 2003 (JP) 2003-313258
Oct. 3, 2003 (JP) 2003-345525

(51) Int. Cl. H02K 21/14

(52) U.S. Cl. 310/156.44

(57) ABSTRACT

The objective of the present invention is to provide a configuration of the permanent magnets used for rotors in a rotating electronic device and the method of utilizing the same, thereby improving the efficiency, performance and output thereof. It also intends to provide a rotating electronic device that can be miniaturized. To achieve the above objectives, permanent magnets are arranged radially and circularly on a rotor to control the magnetic flux generated by permanent magnets arranged radially on the rotor to be approximately twice as much as the primary magnetic flux generated by permanent magnets arranged circularly thereon. On the rotating surface of the rotor, a secondary magnetic flux is provided and a shape and width of the grooves are modified such that the magnetic flux distribution resulting from the overall interaction of each magnetic flux generated in each magnetic pole on the rotor appears substantially as a sine wave.

### TECHNICAL FIELD

The present invention relates to a magnetic pole configuration that can improve performance and efficiency for motors or power generators for use in rotary machines or transport devices utilizing magnets.

### TECHNICAL BACKGROUND

Synchronous motors of the present time having permanent magnets embedded therein have been widely used with the knowledge that a permanent magnet-type synchronous motor can operate at constant speed with high efficiency. Particularly, along with the advancement in rare earth material, the performance and miniaturization of permanent magnets have advanced significantly. Nevertheless, the method of using permanent magnets has not been developed fully and the same is true for permanent magnetic-type power generators.

For example, Japanese Patent Publication No. 2001-156947 discloses a magnetic-type electronic motor and power generator. In this prior art, magnets are arranged in a radial manner in the motor or power generator. In addition, to further increase performance, the length of a rotor with magnets introduced therein is made longer in the axial direction than that of a stator, thereby enhancing the magnetic flux generated in the gap between the stator and the rotor.

Japanese Patent Publication No. 2002-238193 discloses another example which is a motor. In this prior art, the magnets are arranged circularly. This invention is characterized by a recessed portion provided in the areas where the ends of the permanent magnets adjoin each other on the outer circumference of a rotor with built-in permanent magnets. This prior art describes that the gap between the inner circumference of the stator and the outer circumference of the rotor is enlarged in the areas where the ends of permanent magnets adjoin each other. In other words, the large magnetic reluctance that exists in the gap causes the magnetic flux distribution between inner circumference of the stator and the outer circumference of the rotor to appear substantially like a sine wave, thereby reducing the cogging torque. Japanese Patent Publication No. 2002-118994 discloses another example.

One of the targets of this invention is a synchronized motor with permanent magnets embedded inside the rotor. To provide a rotor configuration that can reduce the cogging torque without skewing the rotor, the present invention provides a configuration in which the magnetic poles switch from N to S or S to N at different angles. In this case, the permanent magnets are arranged circularly, which is the most popular layout. Nevertheless, the efficiency, performance, and output thereof are not fully developed.

### DISCLOSURE OF THE INVENTION

### Problems to be Solved by the Invention

The present invention intends to solve at least one of the problems described above. The objective of the present invention is to provide a configuration of the permanent magnets used for rotors in a rotary machine and the method of utilizing the same, thereby improving the efficiency, performance and output thereof. It also intends to provide a rotating electronic device that can be miniaturized.

### Means to Solve the Problems

The present invention to attain the abovementioned objectives is described by referring to the solutions step by step.

One aspect of the present invention is a rotary machine utilizing magnets, wherein the magnets are inserted in a radial arrangement on a rotor; and the magnetic pole configurations on a rotor are provided with subsections, which are asymmetrical components, such that the subsections on the rotor reach a point at which they can react to the magnetic poles of the stator not only of the same polarity but also of the opposite polarity in a relative sense.

In another example of the present invention, there is provided a rotary machine utilizing magnets, wherein rotor magnetic poles are arranged not at a uniform pitch or angle but at non-uniform pitch angles with a given relative angular displacement; magnets are inserted to be arranged radially and circularly to construct the rotor; gaps or non-magnetic member portions are provided on the periphery of the magnets such that the magnetic flux generated by the circularly arranged magnets will not directly return to the rotor magnets, thereby increasing magnetic flux in the gap portions in the rotor and the stator.

In still another example of the present invention, there is provided a rotary machine utilizing magnets, wherein the magnets are inserted to be arranged radially on a rotor; and the magnetic pole configurations on a rotor are provided with subsections, which are asymmetrical components, such that the subsections on the rotor reach a point at which they can react to the electromagnetically coupled magnetic poles of the stator not only of the same polarity but also of the opposite polarity in a relative sense.

In still another example of the present invention, there is provided a rotary machine utilizing magnets wherein magnets are inserted to construct the rotor wherein the run-out component of the rotor constructed with magnets is positioned in an area whose length is longer than the axial length of the stator constructed with iron cores electromagnetically coupled by windings; an inner side defined by facing magnets, one arranged radially and the other arranged circularly within the run-out component of the rotor, and having the same polarity; an inner side defined by facing magnets, one arranged radially and the other arranged circularly in a non-run-out component of the rotor having the opposite polarity.

In still another example of the present invention, there is provided a rotary machine and an electromagnetic machine represented by a rotary machine utilizing magnets. A stator comprises magnetic poles constructed with a strong magnetic member and armature windings. On a rotor, permanent magnets are arranged radially and circularly wherein the magnetic flux generated by permanent magnets arranged radially on the rotor is approximately twice as much as the primary magnetic flux generated by permanent magnets arranged circularly thereon. On the rotating surface of the rotor, the grooves are formed on magnetic pole configurations made of a strong magnetic member on the rotor and the shape and width of the grooves are adjusted such that the magnetic flux distribution resulting from the overall interaction of each magnetic flux generated in each magnetic pole on the rotor appears substantially as a sine wave.

In still another example, there is provided a rotary machine utilizing magnets wherein a stator comprises magnetic poles constructed with a strong magnetic member and armature windings. On a rotor, permanent magnets are arranged radially and circularly to control the magnetic flux generated by permanent magnets arranged radially on the rotor to be approximately twice as much as the primary magnetic flux generated by permanent magnets arranged circularly thereon. The circularly arranged permanent magnet generating a primary magnetic flux is provided with permanent magnets generating a secondary magnetic flux thereby increasing the magnetic flux per magnetic pole. On the rotating surface of the rotor, the grooves are formed on magnetic pole configurations made of a strong magnetic member on the rotor and a shape and width of the grooves are modified such that the magnetic flux distribution resulting from the overall interaction of each magnetic flux generated in each magnetic pole on the rotor appears substantially as a sine wave.

In still another example of the present invention, there is a rotary machine and electromagnetic machine wherein an anti-flux loss groove is provided on the rotating shaft side in the radial permanent magnet component on the rotor, and the rotating shaft is made of a non-magnetic member.

In still another example of the present invention, with respect to the intervals between each of the magnetic poles on the rotor, at a minimum, the interval or pitch angle between one magnetic pole and one other magnetic pole is not equal.

In still another example of the present invention, there is provided a rotary machine utilizing magnets, wherein the iron used to construct the iron core component holding permanent magnets on the rotor is replaced with a non-magnetic member, thereby preventing magnetic flux loss between magnets and making the rotating device applicable for a large capacity.

In still another example of the present invention, there is provided is a rotary machine utilizing magnets, wherein the iron used to construct the iron core component holding permanent magnets on the rotor is replaced with a non-magnetic member which is lighter than iron, thereby preventing magnetic flux loss between magnets and making the rotating device applicable for a large capacity.

In still another example of the present invention, the iron used to construct the iron core component holding permanent magnets on the rotor is replaced with a conductive non-magnetic member, thereby preventing magnetic flux loss between magnets, making the rotating device applicable for a large capacity, and providing a self-starting capability.

In still another example of the present invention, there is provided a rotary machine utilizing magnets, wherein slots for attaching magnets are provided on the outer circumferential portion of an iron core component that holds radially arranged magnets on the rotor such that magnetic fields are generated radially by the magnets, causing the magnetic flux of said stator and that of said rotor to react to each other to generate a torque in the rotational direction in a synchronous rotational mode.

In still another example of the present invention, the permanent magnets on the rotor are replaced with electromagnetic coils such as superconductive coils, thereby making the rotating device applicable for a large capacity or for transport devices such as linear motors and the like.

In still another example of the present invention, a portion of the magnets on a radial or circular magnet component can be removed, the magnetic forces of the magnets can be adjusted to modify the magnetic field of the magnetic pole components giving an asymmetrical shape on the rotor, thereby further improving the properties thereof.

### EFFECTS OF THE INVENTION

One aspect of the present invention is a rotary machine utilizing magnets, wherein the magnets are inserted to be arranged radially on a rotor; subsections of the rotor magnetic poles arranged radially are shaped asymmetrically such that subsections of the magnetic pole of the rotor react to the polarity of a stator that is either the same and opposite in a relative sense. When the adjacent stator and the rotor have the same (different) polarity in the primary position, they repel (attract) each other and simultaneously attract (repel) at a subsection position where the stator and the rotor have different (same) polarities. This configuration provides a smooth transition between the reciprocal motions of the stator and the rotor, thereby enhancing the performance of the rotating electronic device and reducing the torque cogging phenomenon that induces vibrations.

Another example of the present invention provides a rotating machine utilizing magnets, wherein rotor magnetic poles are arranged not at a uniform pitch or angle but at non-uniform pitch angles with a given relative angular displacement; magnets are inserted to be arranged radially and circularly to construct the rotor; gaps or non-magnetic member portions are provided on the periphery of the magnets such that the magnetic flux generated by the circularly arranged magnets will not return to the rotor magnets directly, thereby increasing the magnetic flux in the gap portion in the rotor and the stator while reducing the magnetic flux loss thereof. Hence, the rotating electronic device is enhanced in terms of performance and the cogging phenomenon that induces vibrations is diminished.

Another example of the present invention provides a rotary machine utilizing magnets, wherein magnets are inserted to be arranged radially and circularly to the rotor; a subsection of the rotor magnetic poles arranged in a given manner is shaped asymmetrically such that the subsection of the rotor magnetic pole corresponds to the polarities of a stator being electromagnetically coupled being relatively the same or opposite. When the adjacent stator and the rotor have the same (different) polarity in the primary position, they repel (attract) each other and simultaneously attract (repel) at a subsection position where the stator and the rotor have different (same) polarities. This configuration provides a smooth transition between the reciprocal motions of the stator and the rotor, thereby significantly enhancing the performance of the rotating electronic device and significantly diminishing the torque cogging phenomenon that induces vibrations.

Another example of the present invention provides a rotary machine utilizing magnets, wherein magnets are inserted to construct the rotor in the run-out component of the rotor constructed with magnets positioned in an area whose length is longer than the axial length of a stator that is constructed with electromagnetically coupled iron cores; the inner side defined by facing magnets, one arranged radially and the other arranged circularly within the run-out component of the rotor, having the same polarity; the inner side defined by facing magnets, one arranged radially and the other arranged circularly in a non-run-out component of the rotor, having the opposite polarity in a relative sense.

Accordingly, the magnetic flux in the gap portions in the rotor and the stator is significantly increased and the magnetic flux loss is significantly reduced. Hence, the rotating electronic device is significantly enhanced in terms of performance and the cogging phenomenon that induces vibrations is significantly diminished.

Another example of the present invention is a rotary machine and an electromagnetic device incorporating a rotary machine utilizing magnets. A stator comprises magnetic poles constructed with a strong magnetic member and armature windings. Permanent magnets are arranged radially and circularly on a rotor, wherein the magnetic flux generated by the permanent magnets arranged radially on the rotor is approximately twice as much as the magnetic flux generated by permanent magnets arranged circularly thereon. On the rotating surface of the rotor, the grooves are formed on magnetic pole configurations made of a strong magnetic member on the rotor and the shape and width of the grooves are given a fan-like shape in advance to modify the magnetic flux distribution utilizing a fluxmeter in such a manner that the harmonic component of the magnetic flux distribution waveform is reduced from the rotating surface and substantially a sine wave is obtained wherein the magnetic flux is enhanced along the center line of the magnetic poles in the magnetic pole configuration made of a strong magnetic member while being mitigated toward the boundary between adjacent magnetic poles. Additionally, the use of an adjustment groove provides an efficiency of 95% or greater at several kW for a motor in a miniaturized rotating electronic device.

Another example of the present invention provides a permanent magnet type rotary machine utilizing magnets. On a rotor, permanent magnets are arranged radially and circularly to control the magnetic flux generated by permanent magnets arranged radially on the rotor to be approximately twice as much as the primary magnetic flux generated by permanent magnets arranged circularly thereon. The circularly arranged permanent magnet generating a primary magnetic flux is provided with permanent magnets generating a secondary magnetic flux thereby increasing the magnetic flux per magnetic pole. In addition, grooves are formed on magnetic pole configurations made of a strong magnetic member on the rotor and the shape and width of the grooves are given a fan-like shape in advance to modify the magnetic flux distribution utilizing a fluxmeter in such a manner that the harmonic component of the magnetic flux distribution waveform is reduced from the rotating surface and substantially a sine wave is obtained wherein the magnetic flux is enhanced along the center line of the magnetic poles in the magnetic pole configuration made of a strong magnetic member while being mitigated toward the boundary between adjacent magnetic poles. Additionally, the use of an adjustment groove provides an efficiency within the range of 95˜97% at several kW for a motor in a miniaturized rotating electronic device.

Another example of the present invention provides a radial permanent magnet component on the rotor wherein an anti-flux loss groove is provided on the rotating shaft side and the rotating shaft is made of a non-magnetic member, thereby significantly better utilizing the magnetic flux generated therein. The use of an adjustment groove provides an efficiency within the range of 95˜98% at several kW for a motor in a miniaturized rotating electronic device.

Another example of the present invention provides a permanent magnet type rotary machine having the effects described previously, wherein with respect to the interval between each of the magnetic poles on the rotor, at a minimum the interval or pitch angle between one magnetic pole and one other magnetic pole is not equal. In this way, the rotor will not generate cogging torque. Naturally, this unequal interval may be combined with skewing of a magnetic pole in each row and each set.

Another example of the present invention provides a rotary machine utilizing magnets, wherein the iron used to construct the iron core component holding permanent magnets on the rotor is replaced with a non-magnetic member. This configuration does not lose magnetic flux between magnets when the size of the rotor is increased and allows the rotor to be applicable to devices of a large capacity.

Another example of the present invention provides a rotary machine utilizing magnets, wherein the iron used to construct the iron core component holding permanent magnets on the rotor is replaced with a non-magnetic member which is lighter than iron. This configuration does not lose magnetic flux between magnets and allows the rotor to be applied to a device of a large capacity. Additionally, it can also reduce the weight of the rotor itself and the shaft, and the amount of bearing loss.

Another example of the present invention is an improvement, wherein the iron used to construct the iron core component holding permanent magnets on the rotor is replaced with a conductive non-magnetic member. This configuration does not lose magnetic flux between magnets and allows the rotating device to be applicable to a large capacity. It also reduces the weight of the rotor and provides a self-starting capability.

Another example of the present invention provides a rotary machine utilizing magnets, wherein slots for attaching magnets are provided on the outer circumferential portion of an iron core component holding radially arranged magnets on the rotor such that magnetic fields are generated radially by the magnets, causing the magnetic flux of said stator and that of said rotor to react to each other to generate a torque in the rotational direction in a synchronous rotational mode.

Another example of the present invention is an improvement wherein the permanent magnets on the rotor are replaced with electromagnetic coils such as superconductive coils, thereby encompassing transport device applications that require a significantly higher output and higher efficiency such as linear motors and similar rotating electronic devices.

Another example of the present invention is an improvement wherein a portion of the magnets on a radial or circular magnet component can be removed, and the magnetic forces of the magnets can be adjusted to modify the magnetic field of the magnetic pole components given an asymmetrical shape on the rotor, thereby further improving properties thereof.

### BRIEF DESCRIPTION OF THE DRAWINGS

The foregoing and other objects, advantages, effects and aspects of the invention will be better understood from the following detailed description of the invention with reference to the drawings, in which:

FIG. 1 is a rotating electronic device of Embodiment 1 of the present invention.

FIG. 2 is a diagram illustrating rotor 21 of Embodiment 1 of the present invention.

FIG. 3 is a diagram showing an example of a conventional rotor.

FIG. 4 is a diagram illustrating rotor 22 of Embodiment 2 of the present invention.

FIG. 5 is a diagram showing another example of a conventional rotor.

FIG. 6 is a diagram illustrating rotor 23 of Embodiment 3 of the present invention.

FIG. 7 is a diagram illustrating the magnetic flux of rotor 24a, 24b and the magnetic flux of stator 3 of Embodiment 4 of the present invention.

FIG. 8 is a diagram illustrating rotor 24a of Embodiment 4 of the present invention.

FIG. 9 is a cross-sectional diagram illustrating the rotating electronic device of Embodiment 5 of the present invention.

FIG. 10 is a cross-sectional diagram illustrating the rotating electronic device of Embodiment 6 of the present invention.

FIG. 11 is a cross-sectional diagram illustrating the rotating electronic device of Embodiment 7 of the present invention.

FIG. 12 is a cross-sectional diagram illustrating the rotating electronic device using magnets for enhancing the driving force of Embodiment 8 of the present invention.

FIG. 13 is a cross-sectional diagram illustrating the rotating electronic device in which a non-magnetic member is used in place of the rotor iron core of Embodiment 8 of the present invention.

### DETAILED DESCRIPTION OF THE INVENTION

Various embodiments of the present invention are described herein.

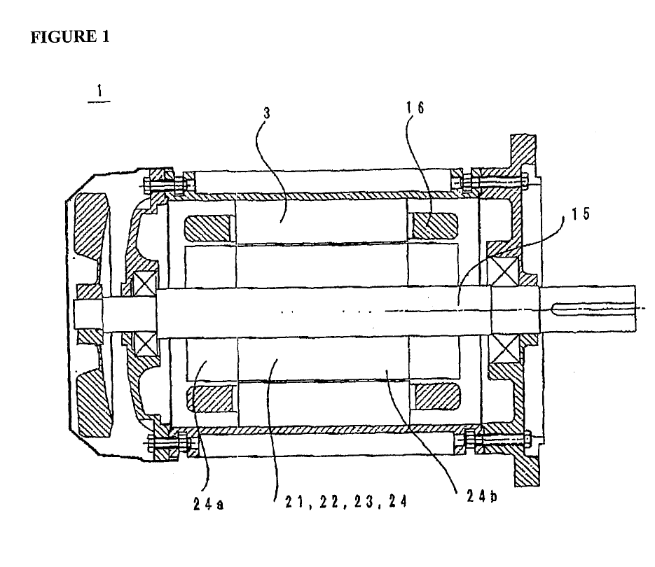

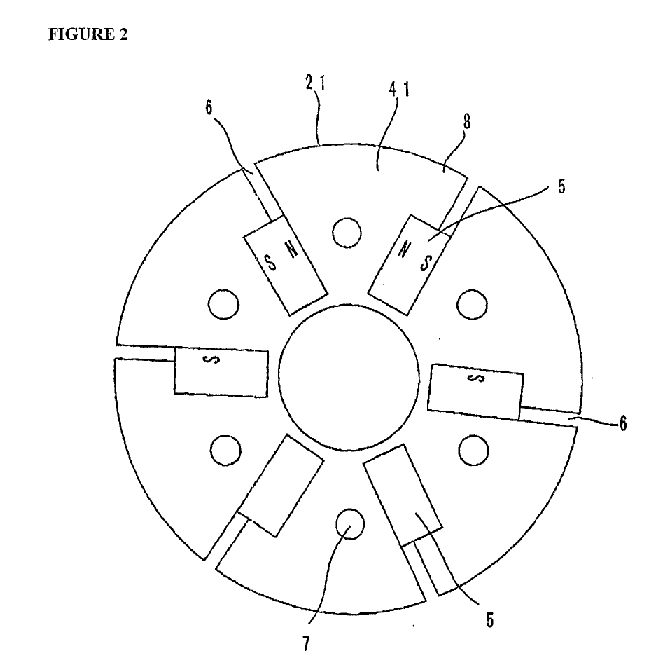

FIG. 1 illustrates the rotating electronic device 1 of Embodiments 1, 2, 3, and 4 together. Reference Numbers 21, 22, 23, and 24 are rotors; 3 is a stator; 15 is a rotating shaft; and 16 is a winding. FIG. 2 shows Embodiment 1 of the present invention. Reference Number 21 is a rotor, 41 is an iron core magnetic pole comprising an electromagnetic steel plate of rotor 21, and 5 is a magnet on rotor 21. Magnets 5 are positioned to form a radial shape on magnetic pole 41. Reference Number 6 is a groove; and 7 is a fitting hole.

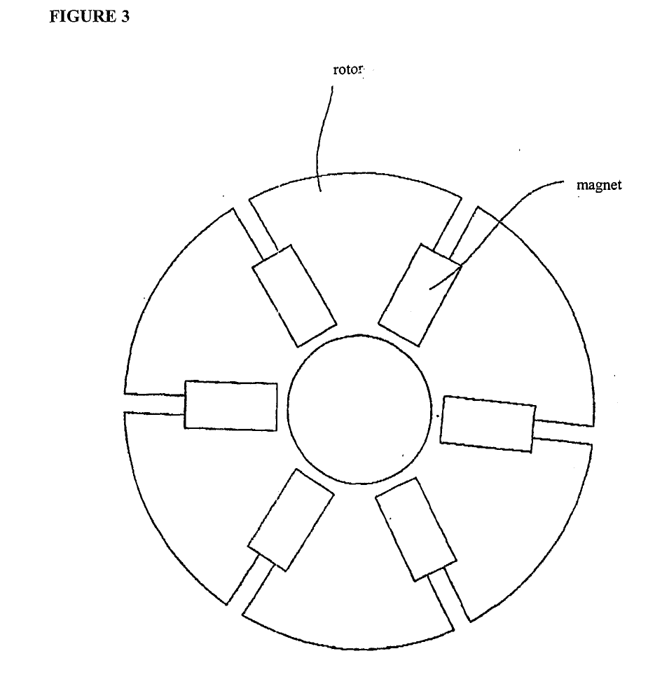

FIG. 3 illustrates an example of rotor configurations in which the rotor magnets are arranged in a conventional radial manner for reference.

In the configuration of the magnetic pole 41 of rotor 21 in which magnets 5 are arranged radially, subsections 8 of the magnetic poles 41 of rotor 21 are given a projecting configuration which is formed asymmetrically. Conventionally, subsections 8 are formed symmetrically. Rotors 21 may be flipped and overlaid via fitting hole 7 provided on rotor 21. The superpositioned pole 41 on the rotor thus provides an aggregate angle that is larger than that of a single rotor 21. As a result, the subsections on the rotor reach a point at which they can react to magnetic poles of the stator not only having the same polarity but also having the opposite polarity in a relative sense.

In rotating electronic device 1 which operates as a power generator or motor, when the [adjacent] stator 3 and the rotor 21 have the same (or different) polarity in the primary position, they repel (or attract) each other and simultaneously attract (repel) at a subsection position where adjacent stator 3 and rotor 21 have different [(same)] polarities. This configuration provides a smooth transition between the reciprocal motions of the stator and the rotor, thereby enhancing the performance of rotating electronic device 1 and reducing the torque cogging phenomenon that induces vibrations.

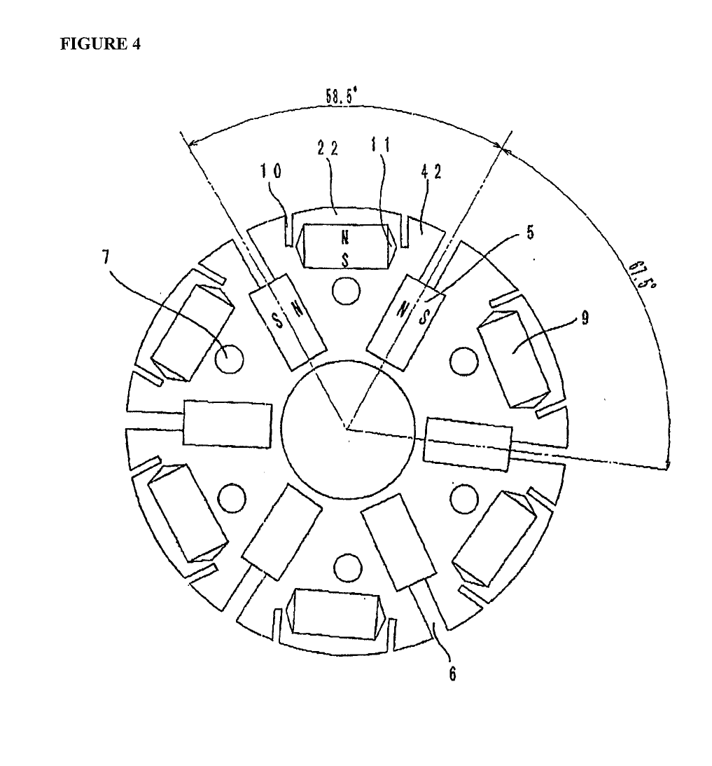

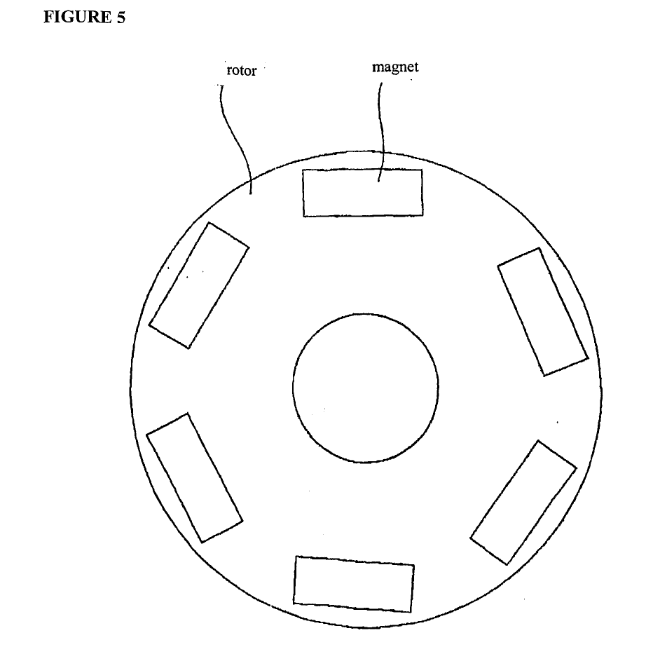

FIG. 4 illustrates Embodiment 2 of the present invention. Reference Number 22 is a rotor, and 42 is an iron core made of electromagnetic steel plates on a rotor. On magnetic pole 42, magnets 5 are arranged radially, magnets 9 are arranged circularly, and grooves 10 and 11 are provided thereon. An iron core magnetic pole is made of electromagnetic steel plates. FIG. 5 illustrates the rotor configuration, for reference, on which magnets are arranged in a conventional radial fashion. Gaps or non-magnetic member portions are provided on the periphery of the magnets to prevent the magnetic flux generated by the circularly arranged magnets from directly returning to magnets 9, thereby increasing the magnetic flux that is present in the gap portions in the rotor and the stator.

Magnets 5 are arranged to face adjacent magnets having the same polarity. Magnets 5 on rotor 21 have for example 6 magnetic poles which are arranged not at an interval of 60 degrees but arranged in the following manner: each of the five magnetic poles is positioned at an angle pitch expressed as 60 degrees×(170˜176)/180. The remaining one magnetic pole is positioned at an angle expressed as 60 degrees+5 degrees×(170˜176)/180. On the other hand, magnets 5 on stator 3, in the case where there are 6 magnetic poles thereon, are separated at an interval of 60 degrees. Therefore, magnets 5 on rotor 21 are positioned with some relative displacement with respect to the magnets on stator 3 that are electromagnetically coupled.

The use of this configuration significantly improves the performance of rotating electronic device 1 and significantly suppresses the torque cogging, consequently reducing vibrations and the like.

Rotor 21 is provided with slots arranged radially for inserting magnets 5 into magnetic poles 41, 42 of each magnetic pole iron core such that the lengths of magnets 5 can be adjusted in a radial direction. The capability of adjusting the radial length of magnets 5 and the presence of radial slots for inserting magnets 5 allow the use of magnets sized to fill out the slots. Accordingly, to obtain a particularly strong magnetic flux, strong magnets or full sized magnets that fill out the slots must be selected. The use of a detachable configuration for magnets 5, 9 makes changing or adjusting the properties of a motor or power generator easy.

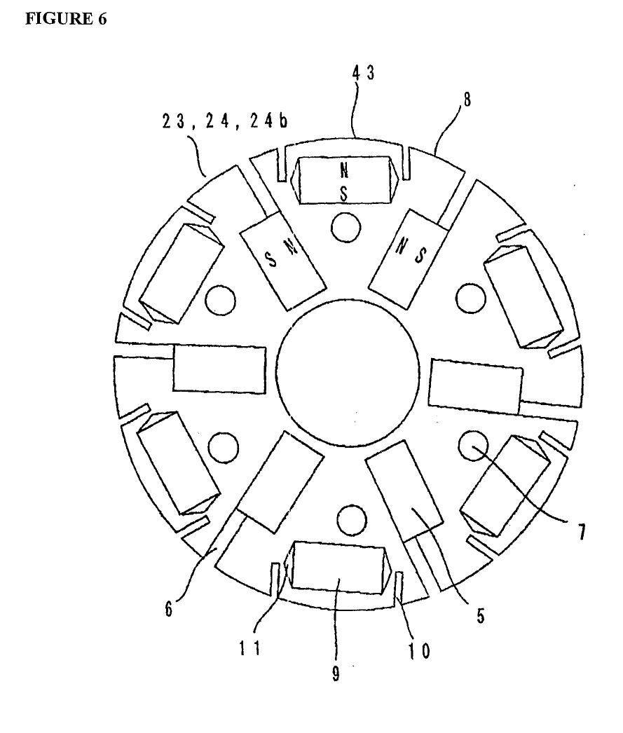

FIG. 6 illustrates Embodiment 3 of the present invention. Reference Number 23 is a rotor; 43 is an iron core magnetic pole of rotor 23 made of electromagnetic steel plates.

On magnetic pole 43 of rotor 23, magnets 5 are arranged radially and subsections 6 are provided on the magnetic pole 43 configuration. Magnets 9 are arranged circularly and gaps or non-magnetic members are provided on grooves 10, 11 around magnets 9.

The combination of Embodiments 1 and 2 gives this configuration. Accordingly, this configuration provides the synergistic effects derived from characteristics of the two embodiments.

For this reason, along with the significant increase in the magnetic flux in the gap portions of rotor 23 and stator 3, a significant increase in performance, a significant increase in cogging torque suppression and a significant reduction in vibration are accomplished by means of a coupling displacement between the magnetic poles on rotor 23 and stator 3, and the presence of subdivisions in the form of projection configurations 8 and the like provided between magnetic poles on rotor 23 and stator 3.

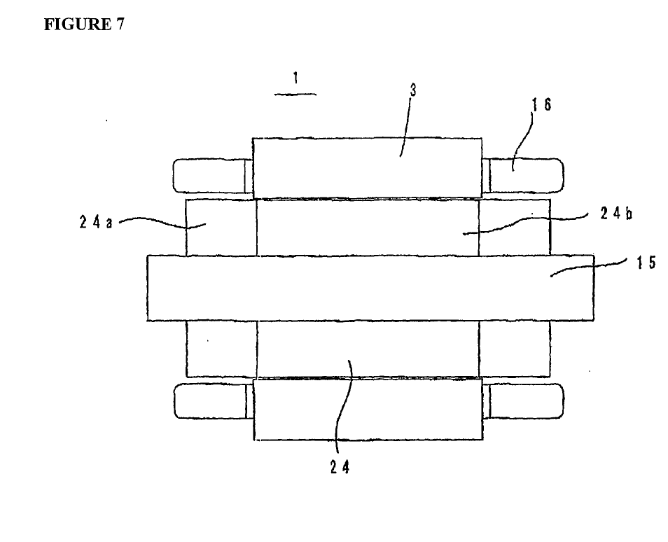

FIGS. 7 and 8 illustrate Embodiment 4 of the present invention. Reference Number 1 is a rotating electronic device; any one of 24, 24a, 24b is a rotor; 3 is a stator; 44 is an iron core magnetic pole made of electromagnetic steel plates of rotors 24a, 24b. In rotating electronic device 1, magnets 5, 9 are inserted to construct the rotor wherein the run-out component of the rotor 24 is constructed with magnets 5, 9 positioned in an area whose length is longer than the axial length of the stator 3 constructed with iron cores electromagnetically coupled by windings 16; the inner side defined by facing magnets 5, 9, of which 5 is arranged radially and 9 is arranged circularly within the run-out component of the rotor 24, having the same polarity; the inner side defined by facing magnets 5, 9, of which 5 is arranged radially and 9 is arranged circularly in a non-run-out component of the rotor, having the opposite polarity.

According to the above configuration as shown in FIG. 4, in the “run-out area” 24a on rotor 24, the magnetic flux is generated along the arrow; in the “non-run-out area” 24b on rotor 24, the magnetic flux is generated along the other arrow. In effect, the magnetic flux generated in the “run-out area” 24a and that in the “non-run-out area” are superpositioned. This configuration allows a significant increase in the magnetic flux in the gap portion in proportion to the length of the “run-out area” on rotor 24 and stator 3. Hence, rotating electronic device 1 obtains significantly advantageous effects in terms of superior performance, reduced torque cogging, and suppressed vibrations.

As a result, even though the rotating electronic device 1 is small in size, it can attain an excellent efficiency of 95˜98%. Compared to the rotating electronic device 1 of conventional technology, the present invention can be much smaller.

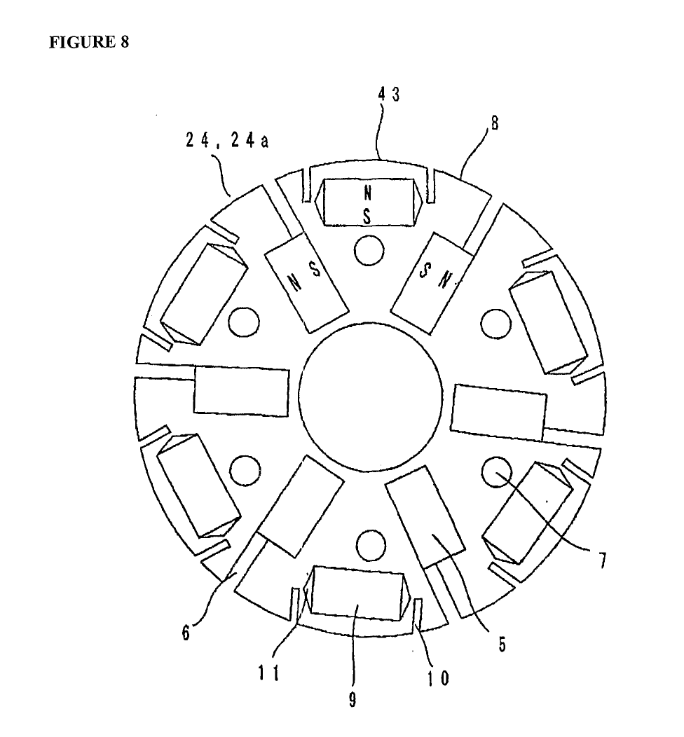

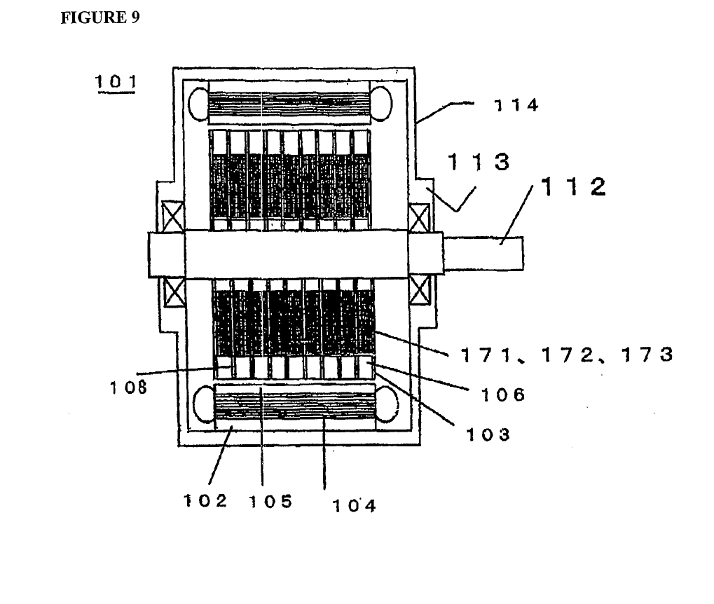

FIGS. 9, 10, 11, 12, and 13 are cross-sectional views of the rotating electronic device of other specific configurations.

101, 101′, 102, 102′ are permanent magnet type rotating electronic devices of the present invention. Reference Number 102 is a stator, 103 is a rotor. Stator 102 is constructed with armature windings 104 and stator magnetic pole iron cores 105. Rotor 103 is constructed in such a manner that permanent magnets 171, 172, and 173 [as shown in FIG. 9] are combined and arranged radially and circularly for each magnetic pole. Reference Number 108 is a partition-assembly plate that isolates the phase derived from each permanent magnet of each phase. FIG. 9 illustrates a configuration of rotor 103 having three rows and three sets.

Note that Reference Number 112 is a rotating shaft; 113 is a rotating bearing; and 114 is a casing.

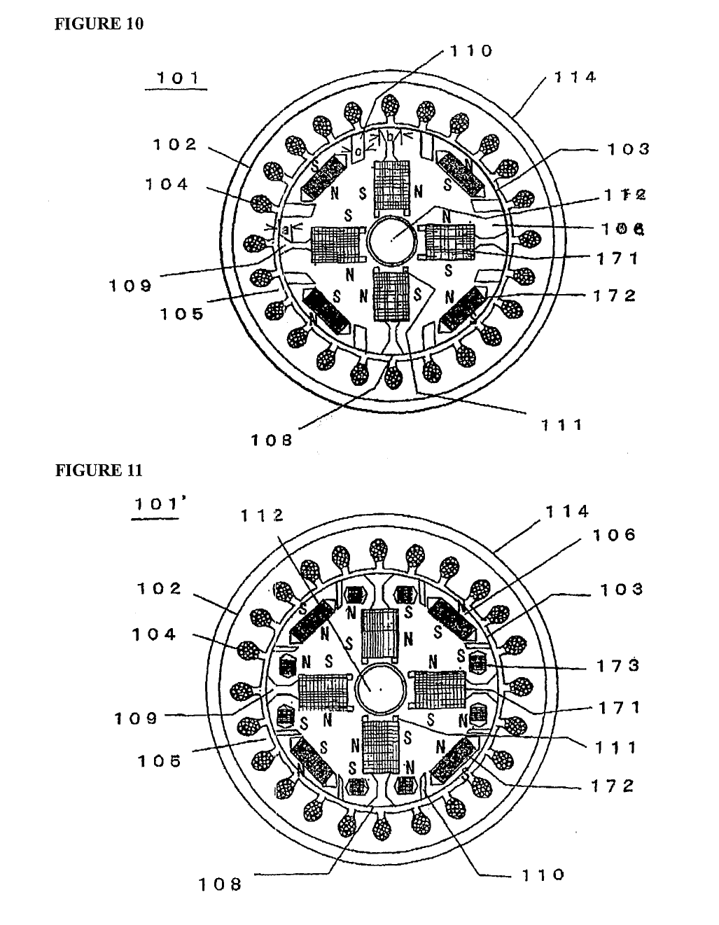

In FIGS. 10 and 11, in the rotor magnetic pole iron cores 106, the magnetic flux derived from permanent magnets 171 arranged radially on each rotor 103 is about twice as much as that of permanent magnets 172 arranged circularly thereon.

Regarding the magnetic flux of permanent magnets 171 arranged radially on rotor 3 and the magnetic flux of permanent magnets 172 arranged circularly on rotor 3, the magnetic flux distribution can be adjusted in advance using a fluxmeter by providing fan-shaped configurations a, b of groove 109 and width c of adjustment groove 110 on the rotating surface of each magnetic pole on stator 102 and rotor 103.

The above configuration reduces the harmonic content in the magnetic flux distribution waveform generated by each magnetic pole on the rotating surface, thereby making the waveform substantially a sine wave.

Regarding the magnetic flux of permanent magnets 171 arranged radially on rotor 3 and the primary magnetic flux of permanent magnets 172 arranged circularly on rotor 3, the magnetic flux distribution can be adjusted in advance using a fluxmeter by providing fan-shaped configurations a, b of groove 109 and the amount of secondary magnetic flux in accordance with the size or similar factor of permanent magnets 173 on the rotating surface of each magnetic pole on stator 102 and rotor 103.

The above configuration enhances the amount of flux and reduces the harmonic content in the magnetic flux distribution waveform generated by each magnetic pole on the rotating surface, thereby making the waveform substantially a sine wave.

To prevent the magnetic flux of permanent magnets 171 arranged radially on rotor 103 to be lost from the rotating shaft side, anti-flux loss groove 111 is provided and rotating shaft 112 is made of a non-magnetic member. This configuration effectively enhances the magnetic flux on the rotating surface.

With respect to the interval between magnetic poles on rotor 103, in the quadruple magnetic pole configuration, as shown in FIGS. 10 and 11 for example, it is easy to arrange three of the magnetic poles at an pitch angle of 88 degrees while arranging the remaining magnetic pole at 96 degrees apart not illustrated. The use of a minimum of one magnetic pole arranged at an uneven interval in the above configuration or similar consideration prevents the rotor from experiencing a cogging torque. Naturally, the use of an uneven interval may be used together with skewing of the magnetic poles in each row and each set.

According to the constitution of the present invention, a power generator used in miniaturized rotating electronic devices 101, 101′ obtains a high efficiency of 95˜98% at a high output of several kW.

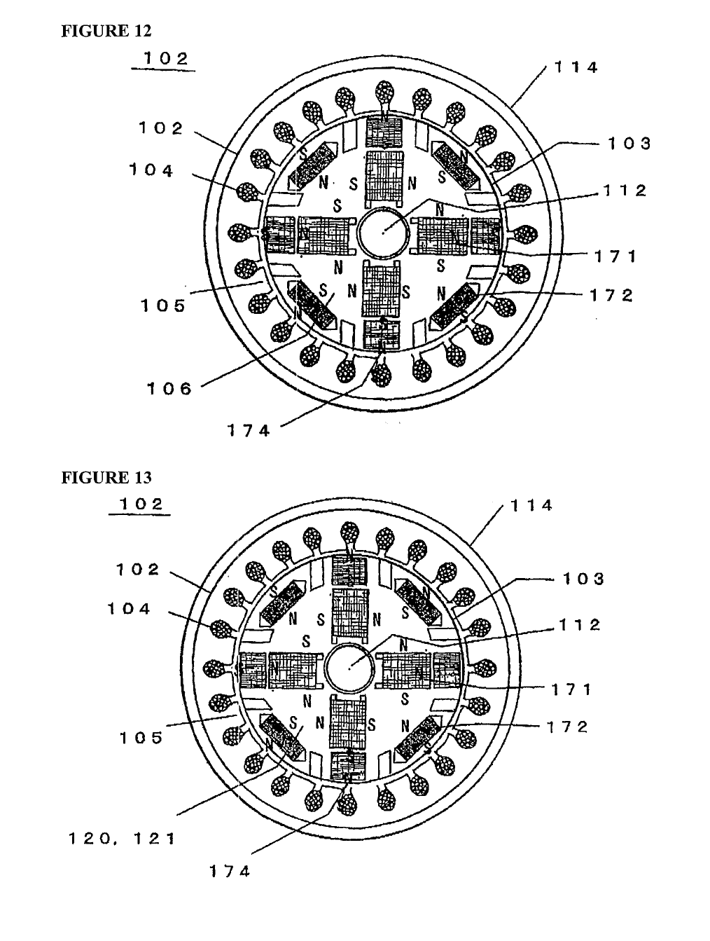

In miniaturized rotating electronic device 102 as illustrated in FIG. 12 which works as a power generator, new slots are provided to the outer circumferential portion for the magnets 171 inserted into the slots arranged radially about rotor iron cores 106 on rotor 105 of the present invention. Magnets 174 are inserted into the new slots such that the magnetic fields point in a radial direction such that repulsive and attractive forces are always generated between the magnetic pole formed on a stator and magnets 174 while the rotor spins at a synchronized speed to generate a driving force at all times during spinning. Hence the output is increased and efficiency is improved.

In addition, in miniaturized rotating electronic device 102′, which functions as a power generator, the use of non-magnetic member 120 or conductive non-magnetic member 121 for construction of rotor iron cores 106 of rotor 105 of the present invention further increases the output and efficiency, and allows the rotating electronic device to be activated by induction.

The use of electromagnets of superconductive material for permanent magnets 171, 172, 173, and 174 for the construction of rotor 103 allows the rotating electronic device to produce a high output and operate at a high efficiency.

### POSSIBLE INDUSTRIAL APPLICATIONS

The present invention finds a wide range of useful applications including general industrial equipment, home appliances, automobile or vehicle devices, air power, water power or thermal power electronic devices, and medical equipment.

Changes may be made in the embodiments of the invention described herein, or in parts or elements of the embodiments described herein, or in the sequence of steps of the methods described herein, without departing from the spirit and/or scope of the invention as defined in the following claims.

1. A rotary machine utilizing magnets, wherein said magnets are inserted to be arranged radially on a rotor; and magnetic pole configurations on a rotor are provided with subsections, which are asymmetrical components, such that said subsections of said rotor reach a point at which they can react to magnetic poles of said stator not only of the same polarity but also of the opposite polarity in a relative sense.

2. A rotary machine utilizing magnets, wherein rotor magnetic poles are arranged not at a uniform pitch or angle but at various angles with a given relative displacement; magnets are inserted to be arranged radially and circularly to construct said rotor; gap or non-magnetic member portions are provided on the periphery of said magnets such that the magnetic flux generated by said circularly arranged magnets will not return to said rotor magnets directly, thereby increasing the magnetic flux density in said gap portions on said rotor and said stator.

3. A rotary machine utilizing magnets, wherein said magnets are inserted to be arranged radially on a rotor; and magnetic pole configurations on a rotor are provided with subsections, which are asymmetrical components, such that said subsections on said rotor reach a point at which they can react to electromagnetically coupled magnetic poles of said stator not only of the same polarity but also of the opposite polarity in a relative sense.

4. A rotary machine utilizing magnets wherein magnets are inserted to construct said rotor wherein the run-out component of said rotor constructed with magnets positioned in an area whose length is longer than the axial length of said stator constructed with electromagnetically coupled iron cores; the inner side defined by facing magnets, one arranged radially and the other is arranged circularly within said run-out component of said rotor having the same polarity; the inner side defined by facing magnets, one arranged radially and the other arranged circularly in a non-run out component of said rotor having the opposite polarity.

5. A rotary machine utilizing magnets, wherein
a stator comprises magnetic poles constructed with a strong magnetic member and armature windings;
permanent magnets are arranged radially and circularly on a rotor wherein the magnetic flux generated by permanent magnets arranged radially on said rotor is approximately twice as much as the magnetic flux generated by permanent magnets arranged circularly thereon;
on the rotating surface of said rotor, said grooves are formed on magnetic pole configurations made of a strong magnetic member on said rotor and the shape and width of said grooves are modified such that the magnetic flux distribution resulting from the overall interaction of each magnetic flux generated in each magnetic pole on said rotor appears substantially as a sine wave.

6. A rotary machine utilizing magnets, wherein
a stator comprises magnetic poles constructed with a strong magnetic member and armature windings;
permanent magnets are arranged radially and circularly on a rotor to control the magnetic flux generated by permanent magnets arranged radially on said rotor to be approximately twice as much as the primary magnetic flux generated by permanent magnets arranged circularly thereon;
said circularly arranged permanent magnets generating a primary magnetic flux are face to face with permanent magnets provided to generate a secondary magnetic flux;
on the rotating surface of said rotor, said grooves are formed on magnetic pole configurations made of a strong magnetic member on said rotor and a shape and width of said grooves are modified such that the magnetic flux distribution resulting from the overall interaction of each magnetic flux generated in each magnetic pole on said rotor appears substantially as a sine wave.

7. The rotary machine as defined in claim 5 wherein on said radial permanent magnet component on said rotor, an anti-flux loss groove is provided on the rotating shaft side and said rotating shaft is made of a non-magnetic member.

8. The rotary machine as defined in claim 5 wherein with respect to the intervals between each of the magnetic poles on said rotor, at a minimum the interval or pitch angle between one magnetic pole and one other magnetic pole are not equal.

9. A rotary machine utilizing magnets, wherein the iron used to construct the iron core component holding permanent magnets on said rotor is replaced with a non-magnetic member, thereby preventing magnetic flux loss between magnets and making the rotating device applicable to a large capacity.

10. A rotary machine utilizing magnets, wherein the iron used to construct the iron core component holding permanent magnets on said rotor is replaced with a non-magnetic member which is lighter than iron, thereby preventing magnetic flux loss between magnets and making the rotating device applicable to a large capacity.

11. The rotary machine as defined in claim 9 wherein said iron used to construct the iron core component holding permanent magnets on said rotor is replaced with a conductive non-magnetic member, thereby preventing magnetic flux loss between said magnets, making the rotating device applicable to a large capacity, and providing self-starting capability.

12. A rotary machine utilizing magnets, wherein slots for attaching magnets are provided on the outer circumferential portion of an iron core component that holds radially arranged magnets on said rotor such that magnetic fields are generated radially by said magnets, thereby causing the magnetic flux of said stator and that of said rotor to react to each other to generate a torque in the rotational direction in a synchronous rotational mode.

13. The rotary machine as defined in any one of claims 1 through 6, 9, 10 and 12 wherein said permanent magnets on said rotor are replaced with electromagnetic coils such as superconductive coils, thereby making the rotating device applicable to a large capacity or to transport devices such as linear motors and the like.

14. The rotary machine as defined in any one of claims 1, 3, 5, 6, 9 10 and 12, wherein a portion of the magnets on a radial or circular magnet component can be removed, magnetic forces of said magnets can be adjusted to modify the magnetic field of said magnetic pole components given an asymmetrical shape on said rotor, thereby further improving the properties thereof.

15. The rotary machine as defined in claim 6 wherein on said radial permanent magnet component on said rotor, an anti-flux loss groove is provided on the rotating shaft side and said rotating shaft is made of a non-magnetic member.

16. The rotary machine as defined in claim 6 wherein with respect to the intervals between each of the magnetic poles on said rotor, at a minimum the interval or pitch angle between one magnetic pole and one other magnetic pole are not equal.

17. The rotary machine as defined in claim 10 wherein said iron used to construct the iron core component holding permanent magnets on said rotor is replaced with a conductive non-magnetic member, thereby preventing magnetic flux loss between said magnets, making the rotating device applicable to a large capacity, and providing self-starting capability.
